(19) United States
(12) Patent Application Publication
(10) Pub. No.: US 2005/0125540 A1
(43) Pub. Date: Jun. 9, 2005

(54) HOME PORTAL ROUTER

(76) Inventors: Oliver Szu, Taipei City (TW); Gary Sze, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,106

(22) Filed: Feb. 10, 2004

Related U.S. Application Data
(63) Continuation-in-part of application No. 10/707,360, filed on Dec. 8, 2003.

(51) Int. Cl. G06F 15/16

(52) U.S. Cl. 709/227

(57) ABSTRACT

A portal web page is used on a router to display all the devices that are known to the router to be devices that can be accessed from within the same network, from another network, or from the Internet. Entries are created in the portal web page from the router's port forwarding table. These entries allow access to a listed device with a single mouse click.

### CROSS REFERENCE To RELATED APPLICATIONS

This is a continuation-in-part of application Ser. No. 10/707,360, filed on Dec. 8, 2003, and which is included in its entirety herein by reference.

### BACKGROUND OF INVENTION

1. Field of the Invention

The present invention relates to automatic creation of entries in a web page using information that resides in a router. More specifically, to a method of creating entries in a router portal web page to allow access to a device connected to a local network from either inside or outside the local network using only a single mouse click.

2. Description of the Prior Art

Routers, also known as routing switches, are used to connect two networks on different domains. Routers have been in use on corporate networks for many years and are now being used at homes as the popularity of the Internet and the number of home PCs has increased in recent years. Access to the Internet is usually provided by an Internet Service Provider (ISP) through various methods such as DSL, Cable modem, and T1 connections. The ISP will assign one or more IP addresses for this connection from a block of public IP addresses which the ISP has obtained, such as the public IP address 12.10.30.15.

Most service providers provide only a single IP address to home subscribers. One of the many functions that a router provides is to allow sharing of a single IP address among many devices such as personal computers and network cameras.

Many companies, including Microsoft, have introduced products that can be connected to a network. These devices can be accessed through the local network which they are connected to by using their IP addresses, usually a private IP address such as 192.168.0.30. In order to gain access to these devices from another network on a different domain or from the Internet, a virtual server, also known as port forwarding, must be setup on the router.

Since there is only one public IP address utilized to refer to multiple devices with different private IP addresses, a public port number needs to be assigned to each device and a forwarding table needs to be setup in the router to maintain the relationships between the private IP address and the corresponding public port number. To access a device with a private IP address of 192.168.0.30 and a public port number of 4300 from the Internet, the public IP address would be 12.10.30.15:4300. Using a virtual server, a router completes the connection from the Internet to the device by forwarding traffic on port 4300 to the device with the private IP address of 192.168.0.30.

Unfortunately, it is difficult for the average user to remember which public port number corresponds to which device on the network. If the user has several network devices that are remotely accessible, extra effort has to be made to remember the public port number corresponding to a chosen device so that the chosen device can be remotely accessed.

### SUMMARY OF INVENTION

It is therefore a primary objective of the claimed invention to automatically generate entries in a router's portal web page to make devices connected to a network accessible from another network on a different domain or from the Internet using a single mouse click.

It is another primary objective of the claimed invention to provide a portal web page for the router through which all the devices connected to the network that can be accessed are listed.

Briefly summarized, the claimed invention discloses a method which displays all the devices connected to a network that can be accessed from another network or the Internet.

In a preferred implementation of the claimed invention, a portal web page is used on a router to display all the devices that are known to the router to be devices that can be accessed from within the same network, from another network, or from the Internet. Entries are created in the portal web page from the router's virtual server, also known as port forwarding, table. These entries allow access to a listed device with a single mouse click.

It is an advantage of the present invention that the portal web page containing the list of devices that can be remotely accessed is automatically generated, allowing the user to simply click on an entry corresponding to a chosen device to access the chosen device. With the aid of the present invention, the user does not need to remember the public port number corresponding to each network device to be remotely accessed.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram showing a router used to forward network traffic.

FIG. 2 is a diagram showing a plurality of network devices connected to the first LAN.

FIG. 3 is a port forwarding table stored in the router.

FIG. 4 is a diagram showing a login page of the portal web page of the router.

FIG. 5 shows a device list page of the portal web page of the router.

FIG. 6 is a diagram showing a login page of a network device connected to the router.

### DETAILED DESCRIPTION

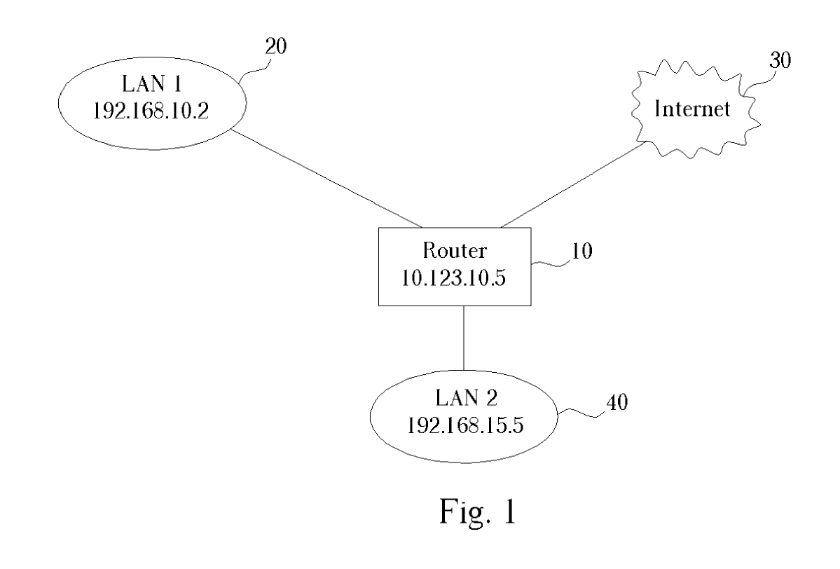

Please refer to FIG. 1. FIG. 1 is a diagram showing a router 10 used to forward network traffic. A first local area network (LAN) 20 is connected to the router 10. The router 10 controls all intra-network traffic of the first LAN 20 as well as all external traffic transmitted and received by the first LAN 20. The router 10 forwards all traffic sent to and received by the public IP address of 10.123.10.5 to the appropriate destination. Within the first LAN 20, the router 10 is assigned a private IP address of 192.168.10.2.

In addition, the router 10 is also connected to the Internet 30 for transmitting data to and receiving data from the Internet 30 using the public IP address of 10.123.10.5. Besides the first LAN 20, the router 10 may also be connected to a second LAN 40. The second LAN 40 is similar to the first LAN 20, but uses a private IP address of 192.168.15.5 for the router 10.

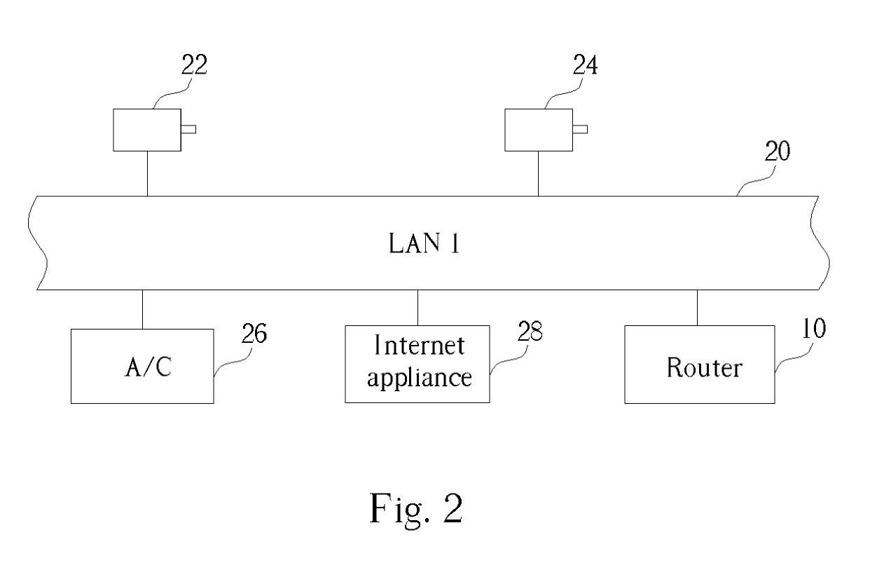

Please refer to FIG. 2. FIG. 2 is a diagram showing a plurality of network devices connected to the first LAN 20. As an example, FIG. 2 shows two network cameras 22 and 24, an air conditioner 26 that can be connected to a network, and a general Internet appliance 28 connected to the first LAN 20. Suppose that the network camera 22 is a network camera placed at the front door of a house to monitor anyone entering, leaving, or approaching the front door. The network camera 24 is a network camera placed in a living room of the house so that the family members in the house can conveniently monitor any activity in the living room. The network devices shown in FIG. 2 are examples devices that can be accessed remotely over a network or over the Internet 30, and other devices may also be used.

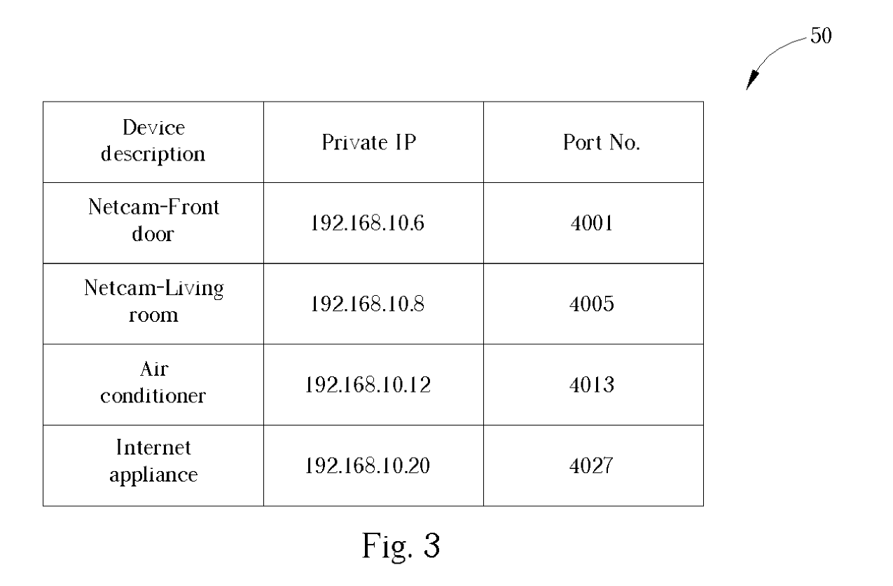

Please refer to FIG. 3. FIG. 3 is a port forwarding table 50 stored in the router 10. The router 10 assigns each network device connected to the first LAN 20 a private IP address and a public port number, and stores this information in the port forwarding table 50 shown in FIG. 3. As the port forwarding table 50 shows, each device has a unique private IP address on the first LAN 20 and has a unique public port number.

Any computer connected to the router 10, including computers in the first LAN 20, the Internet 30, and the second LAN 40, can access any of the network devices located on the first LAN 20 by specifying the public port number of the selected device. For example, the air conditioner 26 can be accessed by typing in the address 10.123.10.5:4013. This address is composed of the public IP address, followed by a colon character, and then followed by the public port number of the air conditioner 26.

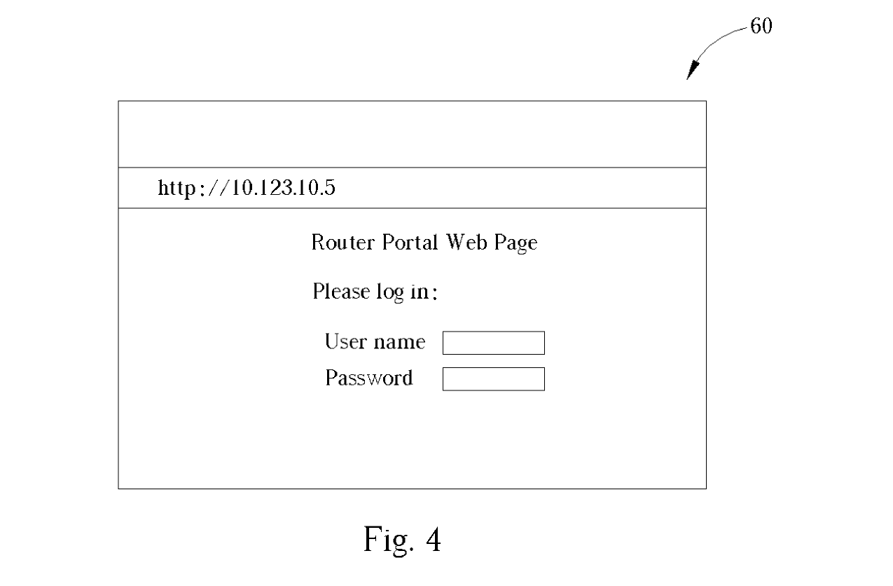

To save users the trouble of having to type in the unique public port number corresponding to each device, the present invention uses the information stored in the port forwarding table 50 to automatically generate a portal web page of the router 10. Please refer to FIG. 4. FIG. 4 is a diagram showing a login page 60 of the portal web page of the router 10. The login page 60 is displayed when a user enters the public IP address of 10.123.10.5 into a web browser. According to the preferences of the administrator of the first LAN 20, a user name and password may be required to access any of the devices on the first LAN 20.

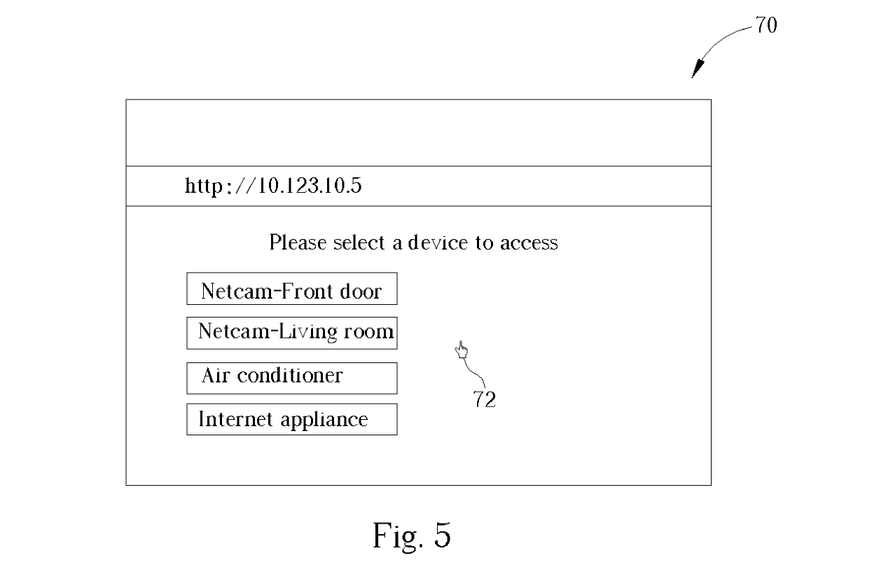

Please refer to FIG. 5. FIG. 5 shows a device list page 70 of the portal web page of the router 10. After logging on through the login page 60, the user is taken to the device list page 70 showing a list of all devices in the first LAN 20 that may be remotely accessed. For instance, as shown in FIG. 5, each device listed in the device list page 70 has a corresponding pictographic or textual indicator. Since the device list page 70 is a web page, each device indicator preferably contains hyperlink to provide a link to the appropriate public IP address including the public port number. A user can use a cursor 72 of a mouse to point to a selected device, and can access the selected device with a single click of the mouse. Of course, other means of choosing the selected device may be used, such as a keyboard or other input devices.

Because some devices on the network are more private than others, individual login pages may be used for each of the network devices. For example, the administrator of the first LAN 20 may wish to allow the general public or a security company to access the network camera 22 at the front door of the house, but at the same time only allowing close family members to access the network camera 24 in the living room.

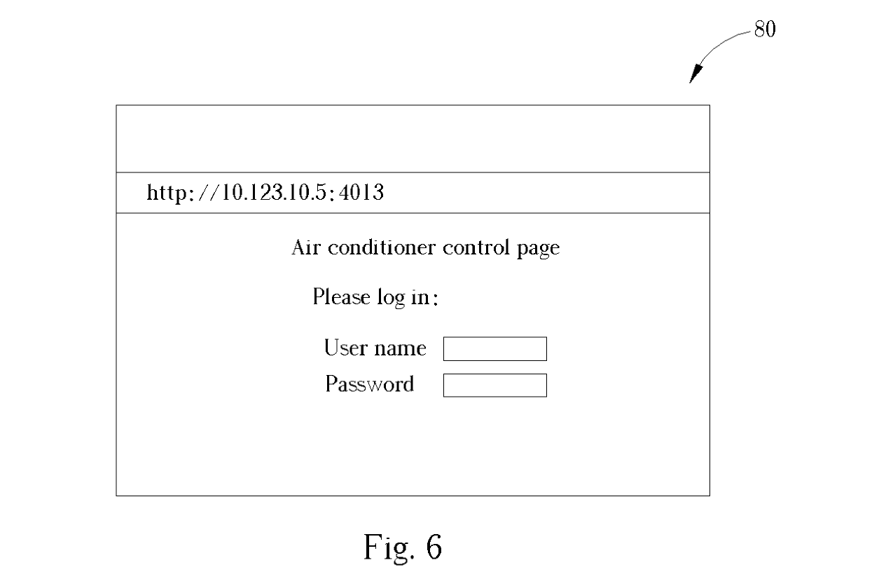

Please refer to FIG. 6. FIG. 6 is a diagram showing a login page 80 of a network device connected to the router 10. Suppose that in the device list page 70 of FIG. 5, the user clicked on the entry for the air conditioner 26. The user is then taken to the address 10.123.10.5:4013. The login page 80 is used to restrict access to the air conditioner 26 to prevent unauthorized users from changing the settings and controls of the air conditioner 26.

Please note that a portal web page can be generated without referencing the port forwarding table 50 stored in the router 10. Instead, a stand alone device can be used to monitor all devices that are connected to a LAN, such as the first LAN 20. Using either the Universal Plug and Play (UPnP) protocol or the Simple Control Protocol (SCP), the stand alone device monitors messages broadcast on the first LAN 20 indicating that a new network device has been connected to the first LAN 20. Each time a new device has been connected, a corresponding new entry is made in the portal web page. Therefore, the portal web page can be generated by the stand alone device attached to the first LAN 20 and not located within the router 10.

If the router 10 is used for generating the port forwarding table 50, the router 10 can also use either the UPnP protocol or the SCP for generating entries in the port forwarding table. Due to the robustness of the UPnP protocol, the router 10 preferably utilizes the UPnP for detecting new network devices added to the first LAN 20.

The main advantage of the present invention method is that the selected device in the first LAN 20 can be accessed by any computer within the first LAN 20, a computer in the second LAN 40 (which has a different domain from the first LAN 20), or any computer connected to the Internet 30. In fact, any computer that is connected to the router 10, either remotely or locally, is capable of accessing a device on the first LAN 20 using the present invention method.

Compared to the prior art, the present invention eliminates the need for the user to remember the public port number corresponding to each network device to be remotely accessed. Instead of typing in both the public IP address and the public port number to access a device on a LAN, the user can instead type only the public IP address of the router for the LAN. Alternatively, the user can type in a registered domain name that points to the public IP address to avoid having to type a long string of numbers. Then, a device located on the LAN can be conveniently accessed with a single mouse click.

Those skilled in the art will readily observe that numerous modifications and alterations of the device may be made while retaining the teachings of the invention. Accordingly, the above disclosure should be construed as limited only by the metes and bounds of the appended claims.

1. A method of accessing a device connected to a local area network (LAN) with a remote apparatus, the method comprising:
providing a router to control data traffic received and transmitted by the LAN, the router being assigned a public internet protocol (IP) address for communicating with an external network;
monitoring the LAN for messages indicating that devices have been connected to the LAN;
determining a public port number for each device connected to the LAN;
generating a portal web page, the portal web page containing a list of each device connected to the LAN and a link to each device, the link containing information indicating the corresponding public port number for each device;
visiting the public IP address of the router with the remote apparatus and viewing the portal web page with a web browser on the remote apparatus;
selecting a device from the list of devices displayed on the portal web page; and
accessing the selected device with the remote apparatus by reading the public port number corresponding to the selected device, appending the public port number to the public IP address of the router to form a public device address, and visiting the public device address.

2. The method of claim 1 wherein the public device address comprises the public IP address and the public port number of the selected device separated by a colon character.

3. The method of claim 1 wherein only a single mouse click is needed for selecting the device from the list of devices displayed on the portal web page.

4. The method of claim 1 wherein a login password is required to access the portal web page.

5. The method of claim 1 wherein a login password is required to access the selected device.

6. The method of claim 1 wherein the selected device is an internet appliance.

7. The method of claim 1 wherein the selected device is a network camera.

8. The method of claim 1 wherein the remote apparatus is located outside the LAN on a different domain from the selected device.

9. The method of claim 8 wherein the remote apparatus accesses the selected device via the Internet.

10. The method of claim 1 wherein the remote apparatus is located inside the same LAN as the selected device.

11. The method of claim 1 wherein monitoring the LAN for messages indicating that devices have been connected to the LAN is performed according to the Universal Plug and Play (UPnP) protocol or the Simple Control Protocol (SCP).

12. A method of accessing a device connected to a local area network (LAN) with a remote apparatus, the method comprising:
providing a router to control data traffic received and transmitted by the LAN, the router being assigned a public internet protocol (IP) address for communicating with an external network;
consulting a forwarding table stored in the router to determine a private IP address and a corresponding public port number for each device connected to the LAN;
generating a portal web page with the router, the portal web page of the router containing a list of each device connected to the LAN and a link to each device, the link containing information indicating the corresponding public port number for each device;
visiting the public IP address of the router with the remote apparatus and viewing the portal web page of the router with a web browser on the remote apparatus;
selecting a device from the list of devices displayed on the portal web page of the router; and
accessing the selected device with the remote apparatus by reading the public port number corresponding to the selected device, appending the public port number to the public IP address of the router to form a public device address, and visiting the public device address.

13. The method of claim 12 wherein the public device address comprises the public IP address and the public port number of the selected device separated by a colon character.

14. The method of claim 12 wherein only a single mouse click is needed for selecting the device from the list of devices displayed on the portal web page of the router.

15. The method of claim 12 wherein a login password is required to access the portal web page of the router.

16. The method of claim 12 wherein a login password is required to access the selected device.

17. The method of claim 12 wherein the selected device is an internet appliance.

18. The method of claim 12 wherein the selected device is a network camera.

19. The method of claim 12 wherein the remote apparatus is located outside the LAN on a different domain from the selected device.

20. The method of claim 19 wherein the remote apparatus accesses the selected device via the Internet.

21. The method of claim 12 wherein the remote apparatus is located inside the same LAN as the selected device.
